(19) United States
(12) Patent Application Publication
(10) Pub. No.: US 2016/0359347 A1
(43) Pub. Date: Dec. 8, 2016

(54) Battery Management Apparatus, Portable Power Source and Battery Management Method

(71) Applicant: Yulong Computer Telecommunication Scientific (Shenzhen) Co., Ltd., Shenzhen (CN)

(72) Inventors: Zhengyi Huang, Shenzhen (CN); Hua He, Shenzhen (CN); Zhigang Chen, Shenzhen (CN)

(21) Appl. No.: 15/242,247

(22) Filed: Aug. 19, 2016

Related U.S. Application Data
(63) Continuation-in-part of application No. PCT/CN2014/072427, filed on Feb. 23, 2014.

(51) Int. Cl. H02J 7/00

(52) U.S. Cl. CPC H02J 7/0029; H02J 7/007; H02J 2007/004

(57) ABSTRACT

The present invention provides a battery management apparatus for a portable power source, including: a monitoring unit used for monitoring a discharge voltage value and a discharge current value of a battery of the portable power source; and a regulation unit used for, when the discharge voltage value of the battery is lower than a first discharge voltage threshold, regulating the discharge current value according to the change of the discharge voltage value, till the discharge voltage value reaches a second discharge voltage threshold. Correspondingly, the present invention further provides a portable power source and a battery management method. By means of the technical solutions of the present invention, the electric quantity of the portable power source can be used to the greatest extent, so as to provide more electric quantity for a device that needs to be charged as much as possible.

### FIELD OF THE INVENTION

The present invention relates to the technical field of batteries, and in particular, to a battery management apparatus, a portable power source and a battery management method.

### BACKGROUND OF THE INVENTION

With rapid development of global economy and continuous improvement of living standards of people, there are more and more portable electronic products, such as laptops, tablet computers, mobile phones, digital cameras, video cameras, portable DVDs, MP3s, MP4s, heat preservation devices, health care devices and the like. However, original batteries of these devices cannot meet the normal use time of the devices due to low battery capacity, and portable power sources have emerged accordingly.

As shown in FIG. 1, the portable power source is a portable device integrating power storage, boosting voltage and charge management. A storage medium (i.e., battery) generally adopts a lithium battery cell, because the lithium battery cell is relatively small in volume, large in capacity, wide in market circulation and moderate in price, the lithium battery is widely used in digital products. The principle thereof is the same as charging a mobile phone. The portable power source is connected to a 5V USB computer interface or a USB charger so as to charge the phone. Therefore, a charge management system is arranged in the portable power source. The charge management system can automatically regulate the charge current according to the voltage of the battery cell, and the processes include pre-charge, constant voltage charge and float charge, etc.

In the traditional portable power source, discharge current is not controlled during the battery discharge according to the discharge ability of the battery, when the battery power of the portable power source is relatively low, the charge current of the apparatus that needs to be charged is overlarge, resulting in that the battery voltage of the portable power source may be dragged down by the heavy load or instantly drop below the protection voltage thereof, as a result, the battery of the portable power source with a relatively large quantity of electricity left is deemed to have no power, and in this case, the functions of the portable power source are not fully developed and utilized.

Therefore, a new technical solution is needed, such that the electric quantity of the portable power source can be used to the greatest extent, so as to provide more electric quantity for a device that needs to be charged as much as possible.

### SUMMARY OF THE INVENTION

Just based on the above problems, the present invention provides a new technical solution, in which the electric quantity of the portable power source can be utilized to the greatest extent, so as to provide more electric quantity for a device that needs to be charged as much as possible.

In view of this, the present invention provides a battery management apparatus for a portable power source, including: a monitoring unit used for monitoring a discharge voltage value and a discharge current value of a battery of the portable power source; and a regulation unit used for, when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, in this way, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the regulation unit is further used for: when the discharge voltage value is higher than the first discharge voltage threshold, judging whether the discharge current value is higher than a discharge current threshold, and regulating the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the battery management apparatus further includes: an acquisition unit used for acquiring the capacity of the battery and determining the discharge current threshold according to the capacity of the battery.

In the technical solution, the discharge current threshold can be determined according to the capacity of the battery.

In the above technical solution, preferably, regulating, by the regulation unit, the discharge current value according to the change of the discharge voltage value specifically includes: in a process that the discharge voltage value gradually decreases from the first discharge voltage threshold to the second discharge threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, the battery management apparatus further includes: a setting unit used for setting the first discharge voltage threshold and/or the second discharge voltage threshold according to a received setting command.

In the technical solution, different first discharge voltage thresholds and second discharge thresholds can be set according to different batteries, so that the electric quantity of each battery can be used to the greatest extent.

According to another aspect of the present invention, a portable power source is further provided, including the battery management apparatus in any above technical solution. The portable power source has the same technical effects as the battery management apparatus, and will not be repeated redundantly herein.

According to another aspect of the present invention, a battery management method is further provided, the battery management method is applied to a portable power source and includes: monitoring a discharge voltage value and a discharge current value of a battery of the portable power source; and when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, thus, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the battery management method further includes: when the discharge voltage value is higher than the first discharge voltage threshold, judging whether the discharge current value is higher than a discharge current threshold, and regulating the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the battery management method further includes: acquiring the capacity of the battery, and determining the discharge current threshold according to the capacity of the battery.

In the technical solution, the discharge current threshold can be determined according to the capacity of the battery.

In the above technical solution, preferably, the regulating the discharge current value according to the change of the discharge voltage value specifically includes: in a process that the discharge voltage value gradually decreases from the first discharge voltage threshold to the second discharge voltage threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, the battery management method further includes: setting the first discharge voltage threshold and/or the second discharge voltage threshold according to a received setting command

In the technical solution, different first discharge voltage thresholds and second discharge thresholds can be set according to different batteries, so that the electric quantity of each battery can be used to the greatest extent.

According to another aspect of the present invention, a portable power source is further provided, comprising: a processor, a memory and a power source management unit, wherein by invoking operation instructions stored in the memory, the processor is used for executing the following operations:

invoking the power source management unit for monitoring a discharge voltage value and a discharge current value of a battery of the portable power source; and

when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, in this way, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the processor is further used for executing the following operations:

when detecting that the discharge voltage value is higher than the first discharge voltage threshold by invoking the power source management unit, the processor judges whether the discharge current value is higher than a discharge current threshold, and regulates the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the processor is further used for executing the following operations:

acquiring the capacity of the battery, and determining the discharge current threshold according to the capacity of the battery.

In the technical solution, the discharge current threshold can be determined according to the capacity of the battery.

In the above technical solution, preferably, the processor is further used for executing the following operations:

in a process that the discharge voltage value gradually decreases from the first discharge voltage threshold to the second discharge threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, the processor is further used for executing the following operations:

setting the first discharge voltage threshold and/or the second discharge voltage threshold. In the technical solution, different first discharge voltage thresholds and second discharge thresholds can be set according to different batteries, so that the electric quantity of each battery can be used to the greatest extent.

According to an embodiment of the present invention, a program product stored on a nonvolatile machine-readable medium is further provided, the program product is applied to battery management, and the program product includes a machine executable instruction used for causing a computer system to execute the following steps: monitoring a discharge voltage value and a discharge current value of a battery of the portable power source; and when the discharge voltage value of the battery is lower than a first discharge voltage threshold, regulating the discharge current value according to the change of the discharge voltage value, till the discharge voltage value reaches a second discharge voltage threshold.

According to an embodiment of the present invention, a nonvolatile machine-readable medium is further provided, a program product for battery management is stored on the nonvolatile machine-readable medium, and the program product includes a machine executable instruction used for causing a computer system to execute the following steps: monitoring a discharge voltage value and a discharge current value of a battery of the portable power source; and when the discharge voltage value of the battery is lower than a first discharge voltage threshold, regulating the discharge current value according to the change of the discharge voltage value, till the discharge voltage value reaches a second discharge voltage threshold.

According to an embodiment of the present invention, a machine readable program is further provided, and the program causes a machine to execute the battery management method in any above technical solution.

According to an embodiment of the present invention, a storage medium storing a machine readable program is further provided, wherein the machine readable program causes a machine to execute the battery management method in any above technical solution.

By means of the technical solutions, the electric quantity of the portable power source can be used to the greatest extent, so as to provide more electric quantity for the device that needs to be charged as much as possible.

### BRIEF DESCRIPTION OF THE DRAWINGS

FIG. 1 shows a schematic diagram of a working principle of a portable power source in the relevant art;

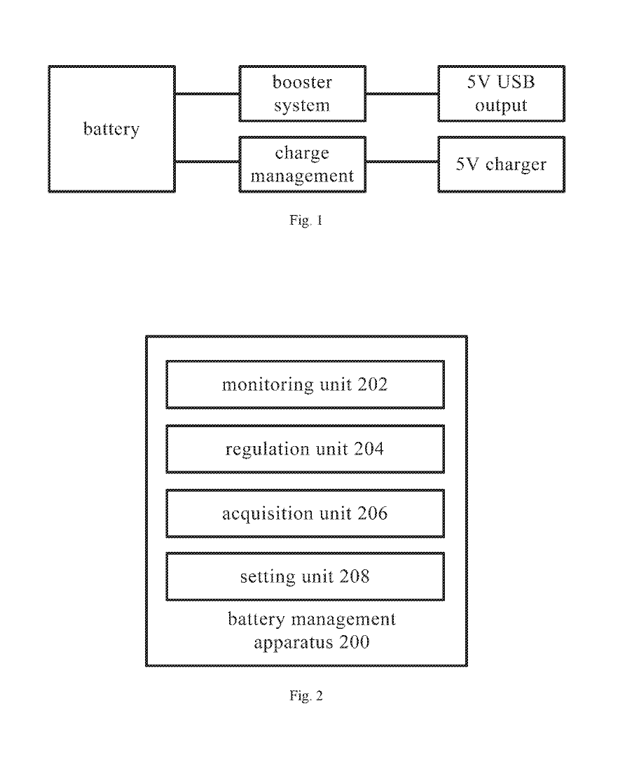

FIG. 2 shows a block diagram of a battery management apparatus according to an embodiment of the present invention;

FIG. 3 shows a flowchart of a battery management method according to an embodiment of the present invention;

FIG. 4 shows a specific flowchart of a battery management method according to an embodiment of the present invention. p FIG. 5 shows a block diagram of a portable power source according to an embodiment of the present invention.

### DETAILED DESCRIPTION OF THE EMBODIMENTS

In order that the above objects, features and advantages of the present invention can be understood more clearly, a further detailed description of the present invention will be given below in combination with the accompany drawings and specific embodiments. It should be noted that embodiments of the present application and the features in the embodiments can be combined with each other without conflict.

A lot of specific details are described in the following description to fully understand the present invention, but the present invention can also be implemented in other ways different from what is described herein, and thus the protection scope of the present invention is not limited by the specific embodiments described below.

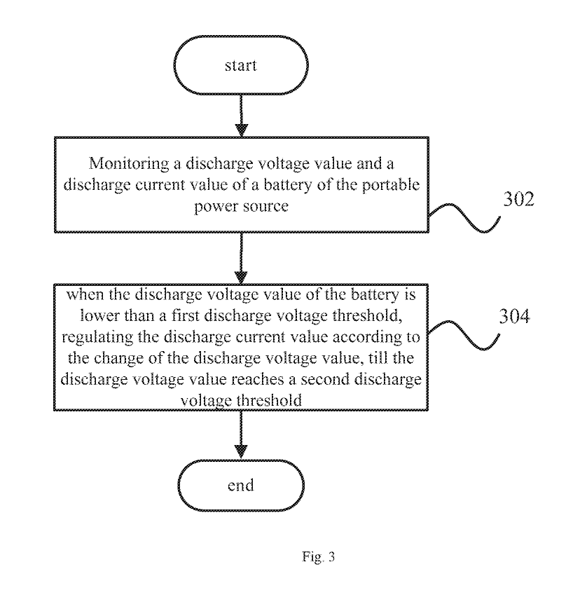

FIG. 2 shows a block diagram of a battery management apparatus according to an embodiment of the present invention.

As shown in FIG. 2, the battery management apparatus 200 according to the embodiment of the present invention includes: a monitoring unit 202 used for monitoring a discharge voltage value and a discharge current value of a battery of the portable power source; and a regulation unit 204 used for, when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, in this way, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the regulation unit 204 is further used for: when the discharge voltage value is higher than the first discharge voltage threshold, judging whether the discharge current value is higher than a discharge current threshold, and regulating the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the battery management apparatus further includes: an acquisition unit 206 used for acquiring the capacity of the battery and determining the discharge current threshold according to the capacity of the battery.

In the technical solution, the discharge current threshold can be determined according to the capacity of the battery.

In the above technical solution, preferably, regulating, by the regulation unit 204, the discharge current value according to the change of the discharge voltage value specifically includes: in a process that the discharge voltage value gradually decreases from the first discharge voltage threshold to the second discharge threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, the battery management apparatus further includes: a setting unit 208 used for setting the first discharge voltage threshold and/or the second discharge voltage threshold according to a received setting command In the technical solution, different first discharge voltage thresholds and second discharge thresholds can be set according to different batteries, so that the electric quantity of each battery can be used to the greatest extent.

According to another aspect of the present invention, a portable power source is further provided, including the battery management apparatus in any above technical solution. The portable power source has the same technical effects as the battery management apparatus, and will not be repeated redundantly herein.

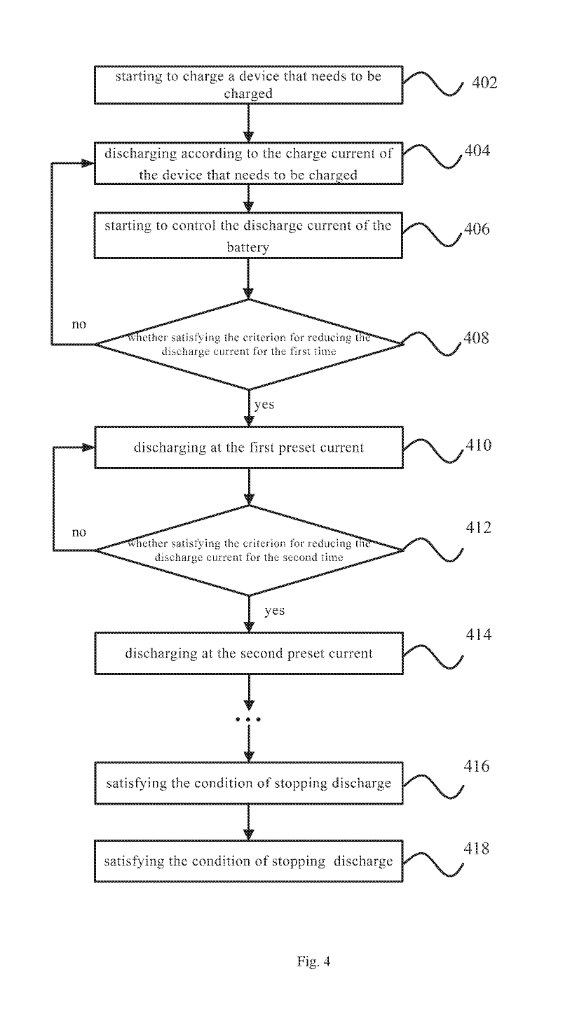

FIG. 3 shows a flowchart of a battery management method according to an embodiment of the present invention.

As shown in FIG. 3, the battery management method according to the embodiment of the present invention includes: step 302, monitoring a discharge voltage value and a discharge current value of a battery of the portable power source; and step 304, when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, thus, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the before the step 304, the battery management method further includes: when the discharge voltage value is higher than the first discharge voltage threshold, judging whether the discharge current value is higher than a discharge current threshold, and regulating the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the battery management method further includes: acquiring the capacity of the battery, and determining the discharge current threshold according to the capacity of the battery.

In the technical solution, the discharge current threshold can be determined according to the capacity of the battery.

In the above technical solution, preferably, the regulating the discharge current value according to the change of the discharge voltage value specifically includes: in a process that the discharge voltage value gradually decreases from the first discharge voltage threshold to the second discharge threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, before the step 302, the battery management method further includes: setting the first discharge voltage threshold and/or the second discharge voltage threshold according to a received setting command.

In the technical solution, different first discharge voltage thresholds and second discharge thresholds can be set according to different batteries, so that the electric quantity of each battery can be used to the greatest extent.

By means of the technical solutions of the present invention, the electric quantity of the portable power source can be used to the greatest extent, so as to provide more electric quantity for the device that needs to be charged as much as possible.

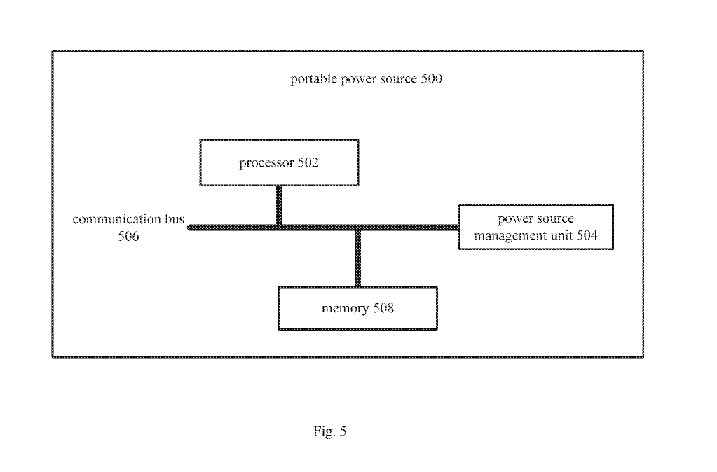

FIG. 4 shows a specific flowchart of a battery management method according to an embodiment of the present invention.

As shown in FIG. 4, the specific flow of the battery management method according to the embodiment of the present invention is as follows:

Step 402, the battery starts to charge a device that needs to be charged.

Step 404, when the electric quantity of the battery does not reach the low electric quantity, namely when the discharge voltage value of the battery does not reach the discharge voltage threshold, discharging is executed according to the charge current of the device that needs to be charged.

Step 406, when the electric quantity of the battery reaches the low electric quantity, namely when the discharge voltage value of the battery reaches the discharge voltage threshold, entering a low power mode, and the discharge current of the battery is started to be controlled.

Step 408, it is judged whether the criterion for reducing the discharge current for the first time is satisfied, when the judgment result is positive, a step 410 is executed, and when the judgment result is negative, the step 404 is executed. In this case, the criterion for reducing the discharge current for the first time can be that the discharge voltage reaches a certain value, for example, the discharge voltage reaches 3.6V. The value of the reduced discharge current can be correspondingly set according to actual conditions.

Step 410, the battery discharges at the first preset current. In this way, regulating the discharge current automatically to ensure small voltage fluctuation, thus it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

Step 412, it is judged that whether the criterion for reducing the discharge current for the second time is satisfied, when the judgment result is positive, a step 414 is executed, and when the judgment result is negative, the step 410 is executed. In this case, the criterion for reducing the discharge current for the second time can be that the discharge voltage reaches a certain value, for example, the discharge voltage reaches 3.4V. The value of the reduced discharge current can be correspondingly set according to actual conditions.

Step 414, the battery discharges at the second preset current. In this case, the second preset current corresponds to the criterion for reducing the discharge current for the second time, and when the criterion for reducing the discharge current for the second time is satisfied, the second preset current is used for discharging.

Step 416, the process thus proceeds, till the condition of stopping discharging is satisfied after reducing the discharge current for N times, namely till the battery is completely discharged. In this way, the electric quantity of the portable power source can be used to the greatest extent, so as to provide more electric quantity for a device that needs to be charged as much as possible.

Step 418, the battery stops discharging.

FIG. 5 shows a block diagram of a portable power source according to an embodiment of the present invention.

As shown in FIG. 5, the portable power source 500 according to the embodiment of the present invention includes: at least one processor 502, for example, a CPU; at least one power source management unit 504, for example, a PMU; at least one communication bus 506; and at least one memory 508; wherein the communication bus 506 is used for realizing the connection among these components; the memory 508 can be a high-speed RAM memory or a non-volatile memory, for example, at least one magnetic disk memory; wherein by invoking operation instructions stored in the memory 508, the processor 502 is used for executing the following operations:

invoking the power source management unit 504 for monitoring a discharge voltage value and a discharge current value of a battery of the portable power source; and

when the discharge voltage value of the battery is lower than a first discharge voltage threshold, regulating the discharge current value according to the change of the discharge voltage value, till the discharge voltage value reaches a second discharge voltage threshold.

In the technical solution, the first discharge voltage threshold can be a low voltage threshold of the battery, and the second discharge voltage threshold can be the protection voltage of the battery. When the discharge voltage of the battery is lower than a certain discharge voltage threshold, namely when the electric quantity of the battery is lower than a certain degree, the discharge current of the battery is automatically regulated to ensure a stable change of the discharge voltage, in this way, it can avoid the probability that when the electric quantity of the battery is relatively low, the voltage of the battery is dragged down by a heavy load or instantly drops below the protection voltage thereof, since the charge current of the device that needs to be charged is overlarge, so that the electric quantity of the portable power source can be used to the greatest extent, so as to provide more electric quantity for the device that needs to be charged as much as possible.

In the above technical solution, preferably, the processor 502 is further used for executing the following operations:

when detecting that the discharge voltage value is higher than the first discharge voltage threshold by invoking the power source management unit 504, the processor 502 judges whether the discharge current value is higher than a discharge current threshold, and regulates the discharge current value to the discharge current threshold when the judgment result is positive.

In the technical solution, when the discharge voltage of the battery does not reach the first discharge voltage threshold, namely when the electric quantity of the battery does not reach low electric quantity and is still in a high electric quantity stage, to protect the battery and prolong the service life of the battery, when the discharge current is higher than the discharge current threshold, regulating the discharge current to the discharge current threshold automatically.

In the above technical solution, preferably, the processor 502 is further used for executing the following operations:

acquiring the capacity of the battery, and determining the discharge current threshold according to the capacity of the battery.

In the technical solution, the discharge current threshold can be determined according to the capacity of the battery.

In the above technical solution, preferably, the processor 502 is further used for executing the following operations:

in a process that the discharge voltage value gradually decreases from the first discharge voltage threshold to the second discharge threshold, gradually decreasing the discharge current value.

In the technical solution, the discharge current can be gradually decreased according to the decrease of the discharge voltage, till all electric quantity of the battery is discharged. Specifically, the values between the first discharge voltage threshold and the second discharge voltage threshold can be divided into several sections, and the discharge current value of each section is set according to actual conditions, thus, in one section, the discharge current value corresponding to the section is used for discharging, with the decrease of the discharge voltage, the discharge current value is also gradually decreased, in this way, since the discharge current is controlled, the phenomenon that when the electric quantity of the battery is not used up, the charging device cannot be charged resulting from the overlarge charge current of the device that needs to be charged will not occur, and the electric quantity of the battery can be used to the greatest extent.

In the above technical solution, preferably, the processor 502 is further used for executing the following operations:

setting the first discharge voltage threshold and/or the second discharge voltage threshold.

In the technical solution, different first discharge voltage thresholds and second discharge thresholds can be set according to different batteries, so that the electric quantity of each battery can be used to the greatest extent.

The technical solutions of the present invention have been illustrated above in detail in combination with the accompany drawings, in related technology, the discharge current is not controlled during the battery discharge according to the discharge ability of the battery, when the battery capacity of the portable power source is relatively low, the charge current of the apparatus that needs to be charged is overlarge, resulting in that the battery voltage of the portable power source may be dragged down by the heavy load or instantly drop below the protection voltage thereof, as a result, the battery of the portable power source with a relatively large quantity of electricity left is deemed to have no power. Therefore, the technical solutions of the present invention are proposed, and by means of the technical solutions of the present invention, the electric quantity of the portable power source can be used to the greatest extent, so as to provide more electric quantity for the device that needs to be charged as much as possible.

According to the embodiment of the present invention, a program product stored on a nonvolatile machine-readable medium is further provided, the program product is applied to battery management, and the program product includes a machine executable instruction used for causing a computer system to execute the following steps: monitoring a discharge voltage value and a discharge current value of a battery of the portable power source; and when the discharge voltage value of the battery is lower than a first discharge voltage threshold, regulating the discharge current value according to the change of the discharge voltage value, till the discharge voltage value reaches a second discharge voltage threshold.

According to the embodiment of the present invention, a nonvolatile machine-readable medium is further provided, a program product for battery management is stored on the nonvolatile machine-readable medium, and the program product includes a machine executable instruction used for causing a computer system to execute the following steps: monitoring a discharge voltage value and a discharge current value of a battery of the portable power source; and when the discharge voltage value of the battery is lower than a first discharge voltage threshold, regulating the discharge current value according to the change of the discharge voltage value, till the discharge voltage value reaches a second discharge voltage threshold.

According to the embodiment of the present invention, a machine readable program is further provided, and the program causes a machine to execute the battery management method in any above technical solution.

According to the embodiment of the present invention, a storage medium storing a machine readable program is further provided, wherein the machine readable program causes a machine to execute the battery management method in any above technical solution.

The foregoing descriptions are merely preferred embodiments of the present invention, rather than limiting the present invention, and for those skilled in the art, the present invention can have a variety of variations and modifications. Any modifications, equivalent substitutions, improvements or the like made within the spirit and principle of the present invention shall all fall into the protection scope of the present invention.

1. A portable power source, comprising a processor, a memory and a power source management unit, wherein by invoking operation instructions stored in the memory, the processor is used for executing the following operations:
invoking the power source management unit for monitoring a discharge voltage value and a discharge current value of a battery of the portable power source; and
when the discharge voltage value of the battery is lower than a first discharge voltage threshold, regulating the discharge current value according to the change of the discharge voltage value, till the discharge voltage value reaches a second discharge voltage threshold.

2. The portable power source of claim 1, wherein the processor is further used for executing the following operations:
when detecting that the discharge voltage value is higher than the first discharge voltage threshold by invoking the power source management unit, the processor judges whether the discharge current value is higher than a discharge current threshold, and regulates the discharge current value to the discharge current threshold when the judgment result is positive.

3. The portable power source of claim 2, wherein the processor is further used for executing the following operations:
acquiring the capacity of the battery, and determining the discharge current threshold according to the capacity of the battery.

4. The portable power source of claim 1, wherein the processor is further used for executing the following operations:
in a process that the discharge voltage value gradually decreases from the first discharge voltage threshold to the second discharge threshold, gradually decreasing the discharge current value.

5. The portable power source of claim 1, wherein the processor is further used for executing the following operations:
setting the first discharge voltage threshold and/or the second discharge voltage threshold.

6. The portable power source of claim 2, wherein the processor is further used for executing the following operations:
setting the first discharge voltage threshold and/or the second discharge voltage threshold.

7. The portable power source of claim 3, wherein the processor is further used for executing the following operations:
setting the first discharge voltage threshold and/or the second discharge voltage threshold.

8. The portable power source of claim 4, wherein the processor is further used for executing the following operations:
setting the first discharge voltage threshold and/or the second discharge voltage threshold.

9. A battery management method, applied to a portable power source, comprising:
monitoring a discharge voltage value and a discharge current value of a battery of the portable power source; and
when the discharge voltage value of the battery is lower than a first discharge voltage threshold, regulating the discharge current value according to the change of the discharge voltage value, till the discharge voltage value reaches a second discharge voltage threshold.

10. The battery management method of claim 9, further comprising:
when the discharge voltage value is higher than the first discharge voltage threshold, judging whether the discharge current value is higher than a discharge current threshold, and regulating the discharge current value to the discharge current threshold when the judgment result is positive.

11. The battery management method of claim 10, further comprising:
acquiring the capacity of the battery, and determining the discharge current threshold according to the capacity of the battery.

12. The battery management method of claim 9, wherein the regulating the discharge current value according to the change of the discharge voltage value specifically comprises:
in a process that the discharge voltage value gradually decreases from the first discharge voltage threshold to the second discharge threshold, gradually decreasing the discharge current value.

13. The battery management method of claim 9, further comprising:
setting the first discharge voltage threshold and/or the second discharge voltage threshold according to a received setting command.

14. The battery management method of claim 10, further comprising:
setting the first discharge voltage threshold and/or the second discharge voltage threshold according to a received setting command.

15. The battery management method of claim 11, further comprising:
setting the first discharge voltage threshold and/or the second discharge voltage threshold according to a received setting command.

16. The battery management method of claim 12, further comprising:
setting the first discharge voltage threshold and/or the second discharge voltage threshold according to a received setting command.
